(19) United States
(12) Patent Application Publication
(10) Pub. No.: US 2012/0013761 A1
(43) Pub. Date: Jan. 19, 2012

(54) IMAGE PICKUP APPARATUS AND A METHOD FOR PRODUCING AN IMAGE OF QUALITY MATCHING WITH A SCENE TO BE CAPTURED

(76) Inventor: Makoto OISHI, Asaka-shi (JP)

(21) Appl. No.: 13/245,722

(22) Filed: Sep. 26, 2011

Related U.S. Application Data
(62) Division of application No. 11/723,137, filed on Mar. 16, 2007.

(30) Foreign Application Priority Data
Mar. 24, 2006 (JP) 2006-84215

(51) Int. Cl. H04N 5/335; H04N 5/228

(52) U.S. Cl. 348/222.1; 348/294; 348/E05.091; 348/E05.031

(57) ABSTRACT

An image pickup apparatus includes an image sensor in which main and auxiliary pixels are bidimensionally arranged for outputting a high and a low output signal, respectively. The user of the camera is allowed to select a desire image quality mode appearing on a monitor by operating a control panel. In a dynamic range priority mode, the high and low output signals are smoothly combined with each other to produce an image signal with a broadened dynamic range. In a resolution priority mode, the high and low output signals are not combined in order to guarantee resolution. In a sensitivity priority mode, the low output signal is added to the high output signal in order to raise the saturation point of the first output signal and therefore sensitivity. Further, in a color reproducibility priority mode, a white balance correcting method is changed depending upon the color temperature of a scene.

This application is a divisional of co-pending application Ser. No. 11/723,137, filed on Mar. 16, 2007, for which priority is claimed under 35 U.S.C. §120, and this application claims priority from Japanese Application No. 2006-84215 filed in Japan on Mar. 24, 2006, under 35 U.S.C. §119. The entire contents of each of the above-identified applications are hereby incorporated by reference.

### BACKGROUND OF THE INVENTION

1. Field of the Invention

The present invention relates to an image pickup apparatus, more specifically to such an apparatus including a solid-state image pickup device in which two kinds of photosensitive portions, respectively corresponding to main pixels and auxiliary pixels, are bidimensionally arranged to constitute a single frame, and also to an image processing method for the same.

2. Description of the Background Art

Japanese patent laid-open publication No. 2004-56568, for example, discloses an image pickup apparatus configured to broaden the dynamic range by combining a high-output signal and a low-output signal produced from high-sensitivity and low-sensitivity photoelectric transducers, respectively, with each other.

In practice, however, it is not always necessary to broaden the dynamic range for every scene. Consequently, the low-output signal produced from low-sensitivity photoelectric transducers are sometimes not used for scenes of the kind not requiring a broader dynamic range.

### SUMMARY OF THE INVENTION

It is an object of the present invention to provide an image pickup apparatus capable of combining two kinds of output signals, i.e., high-output and low-output signals with each other more rationally in accordance with the kind of a scene to be picked up, and an image processing method for the same.

An image pickup apparatus of the present invention includes a solid-state image pickup device in which pixels, constituted by first photosensitive portions and second photosensitive portions lower in sensitivity than the first photosensitive portions, are bidimensionally arranged to form a single frame. The image pickup device is capable of producing, by combining a first and a second output signal produced from the first and said second photosensitive portions, respectively, according to a predetermined rule, an image signal having a broader dynamic range than the first output signal. In a mode giving priority to resolution, a signal processor generates an image signal in which the first and second output signals are used independently of each other without being combined over the single frame.

The signal processor may alternatively be configured to generate, in a mode giving priority to sensitivity, an image signal by adding the first and said second output signals over the single frame.

Further, the signal processor may alternatively be configured to combine, in a mode giving priority to color reproducibility and for an amount of exposure causing the first photosensitive portions corresponding to predetermined one of colors, red (R), green (G) and blue (B), to saturate, a saturation output signal of the first photosensitive portions and an output signal of the second photosensitive portions corresponding to the predetermined color in a predetermined ratio and then establish white balance between a resulting composite output signal and the output signal of the first photosensitive portions corresponding to another color.

A method of processing an image in accordance with the present invention is also practicable with a solid-state image pickup device of the type described. The image processing method begins with the step of selecting any one of a resolution priority mode giving priority to resolution, a sensitivity priority mode giving priority to sensitivity and a color reproducibility priority mode giving priority to color reproducibility. When the resolution priority mode is selected, an image signal is generated by using the first and the second output signals without combining them over the single frame. When the sensitivity priority mode is selected, an image signal is generated by adding the first and second output signal produced from the first and second photosensitive portions, respectively, over the single frame. Further, when the color reproducibility priority mode is selected, an image signal is generated by combining, for an amount of exposure causing the first photosensitive portions corresponding to predetermined one of colors, R, G and B, to saturate, a saturation output signal of the first photosensitive portions and an output signal of the second photosensitive portions corresponding to the predetermined color in a predetermined ratio and then establishing white balance between the resulting composite output signal and the output signal of the first photosensitive portions corresponding to another color. Such a procedure is successful to provide an image signal matching with a user's selection.

The above procedure may be modified, as follows. When the resolution priority mode is selected, an image signal is generated by using the first output signal and the second output signal without combining them over the single frame. When the sensitivity priority mode is selected, an image signal is generated by adding the first and second output signal produced from the first and second photosensitive portions, respectively, over the single frame. When the color reproducibility priority mode is selected, an image signal is generated by combining, for an amount of exposure causing the first photosensitive portions corresponding to predetermined one of colors, R, G and B, to saturate, a saturation output signal of the first photosensitive portions and an output signal of the second photosensitive portions corresponding to the predetermined color in a predetermined ratio and then establishing white balance between the resulting composite output signal and the output signal of the first photosensitive portions corresponding to another color.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of the image pickup apparatus in accordance with the present invention;

FIG. 2 is a view of photodiodes arranged on the image sensing surface of an image sensor included in the apparatus of FIG. 1;

FIG. 3 is a graph plotting the output characteristics of main pixels and auxiliary pixels included in the arrangement of FIG. 2;

FIG. 4 is a rear plan view of a specific configuration of the back of the apparatus shown in FIG. 1;

FIG. 5 is a functional block diagram schematically showing a specific configuration of a signal processor included in the apparatus of FIG. 1;

FIG. 6 demonstrates RGB interpolation processing executed by the signal processor of FIG. 5;

FIGS. 7A, 7B and 7C show other specific patterns in which pixels may be arranged in the image sensor of FIG. 1;

FIG. 8 is a functional block diagram schematically showing another specific configuration of the signal processor included in the apparatus of FIG. 1;

FIG. 9 is a graph useful for understanding combination processing executed by the signal processor of FIG. 8;

FIG. 10 is a functional block diagram schematically showing still another specific configuration of the signal processor included in the apparatus of FIG. 1;

FIGS. 11A and 11B are graphs useful for understanding how a dynamic range is broadened by combination processing included in the signal processor of FIG. 5;

FIG. 12 is a functional block diagram schematically showing a further specific configuration of the signal processor included in the apparatus of FIG. 1;

FIGS. 13A through 13F are graphs useful for understanding the problem of conventional white balance correction;

FIGS. 14A through 14F plot output signals achievable with white balance correction executed by the signal processor of FIG. 12;

FIGS. 15A and 15B are graphs useful for understanding the comparison of spectral sensitivity ratios particular to conventional technologies with spectral sensitivity ratios achievable with the signal processor of FIG. 12;

FIG. 16 is a flowchart demonstrating a specific image processing sequence unique to the embodiment of FIG. 12; and

FIG. 17 is a flowchart showing an automatic image pickup environment analysis procedure executed by a system controller included in the apparatus of FIG. 1.

### DESCRIPTION OF THE PREFERRED EMBODIMENTS

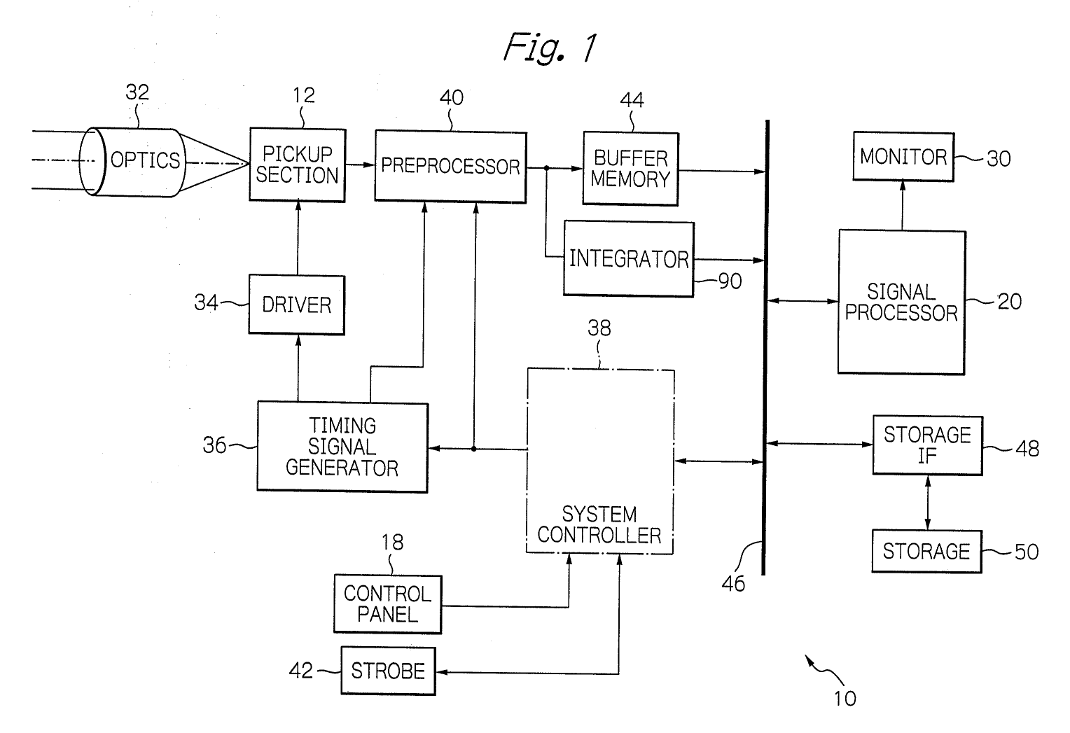

Referring first to FIG. 1 of the accompanying drawings, a first embodiment of the image pickup apparatus in accordance with the present invention is shown in a schematic block diagram and implemented as a digital camera byway of example. As shown, the digital camera, generally 10, includes an image sensor or pickup section 12, which may be of the type of transferring signal charges generated by photodiodes or photoelectric transducers via charge-coupled devices (CCDs) for thereby outputting the signal charges.

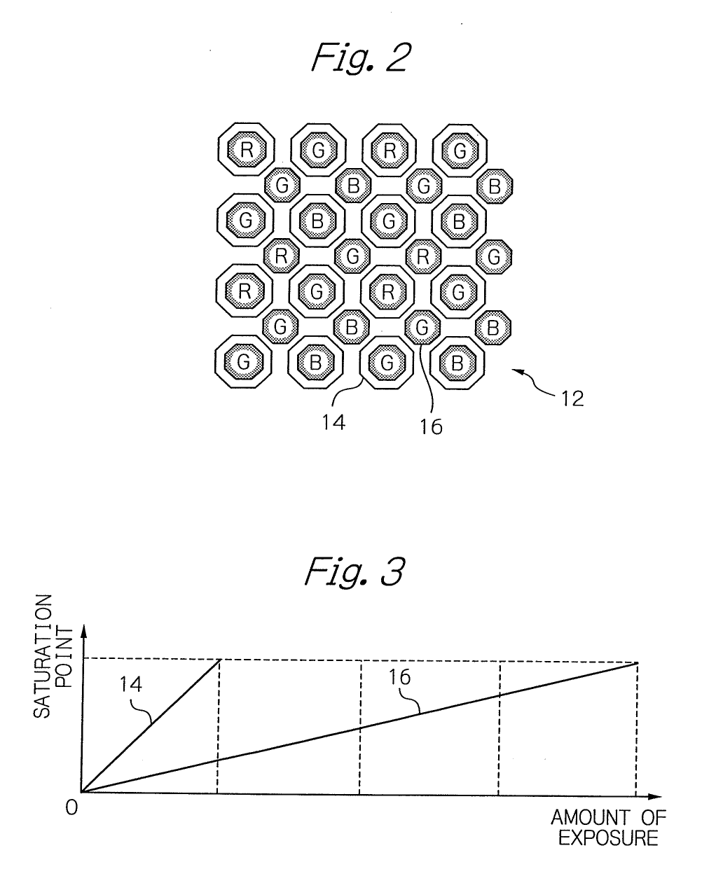

FIG. 2 shows in a plan view part of a specific arrangement of photodiodes arrayed on the image sensing surface of the image sensor 12 formed by CCDs to form a photosensitive cell array. As shown, two kinds of photodiodes constituting main pixels 14 and auxiliary pixels 16, respectively, are arranged on the surface of the image sensor in a Bayer color filter pattern. Of course, the main and auxiliary pixels 14 and 16 may be arranged in any other pattern suitable for the purpose and design of an application. In principle, a single main pixel 14 and a single auxiliary pixel 16 constitute a single pixel in combination. The main pixels 14 have higher sensitivity than the auxiliary pixels 16. Red (R), green (G) and blue (B) color filters, sometimes referred to as filter segments, are each positioned at the light input side of particular one of the main and auxiliary pixels 14 and 16, so that each pixel 14 or 16 outputs a signal charge corresponding to a respective color R, G or B.

FIG. 3 is a graph plotting the output characteristic of the main pixels 14 and that of the auxiliary pixels 16. As shown, although the auxiliary pixels 16 have the same saturation point as the main pixels 14, the former has sensitivity lower than the latter by one-fourth, and can therefore effectively output signal charges in response to a quantity of light four times as great as a quantity of light incident to the latter. Stated another way, the auxiliary pixels 16 output signal charges proportional to energy input thereto. It is therefore possible to implement an image signal having the maximum dynamic range of 400% by smoothly combining high-output signals with low-output signals available with the main pixels 14 and auxiliary pixels 16, respectively, in accordance with the luminance of a scene captured. In practice, however, not all scenes to be picked up need the dynamic range of 400%, but some scenes need high definition rather than such a broad dynamic range.

In light of the above, as shown in FIG. 1, the digital camera 10 includes a control panel 18 that can be operated by the user to select desired one of various image quality modes. With the illustrative embodiment, an image processing method will be described which is to be executed when the user selects on the control panel 18 a resolution priority mode that implements high resolution. As shown in FIG. 1, the digital camera 10 includes a signal processor 20 configured to apply signal processing to the output signal of the image sensor 12 in accordance with the image quality mode selected by the user.

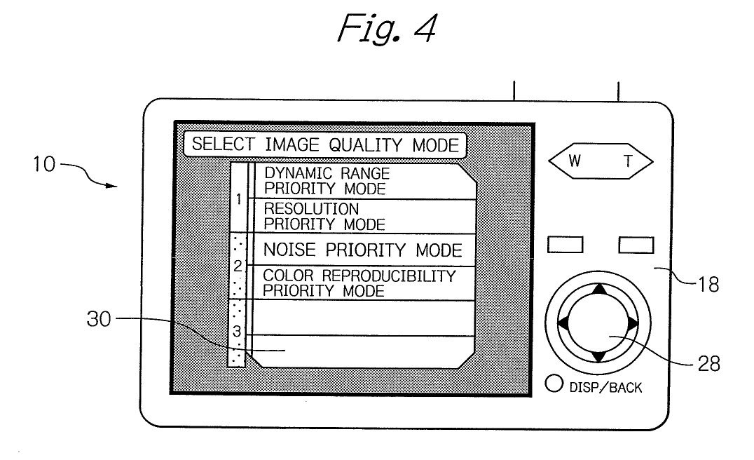

FIG. 4 shows a specific configuration or layout of the back of the digital camera 10 in a plan view. As shown, the control panel 18 is arranged on the back of the camera 10 and includes a direction key 28 as well as other conventional keys. A monitor 30, implemented by a liquid crystal display (LCD) panel by way of example, is also mounted on the back of the camera 10 and capable of displaying an image equality mode list, as illustrated. The user is allowed to freely select desired one of image quality modes available with the camera 10 by manipulating the direction key 28 while watching the monitor 30.

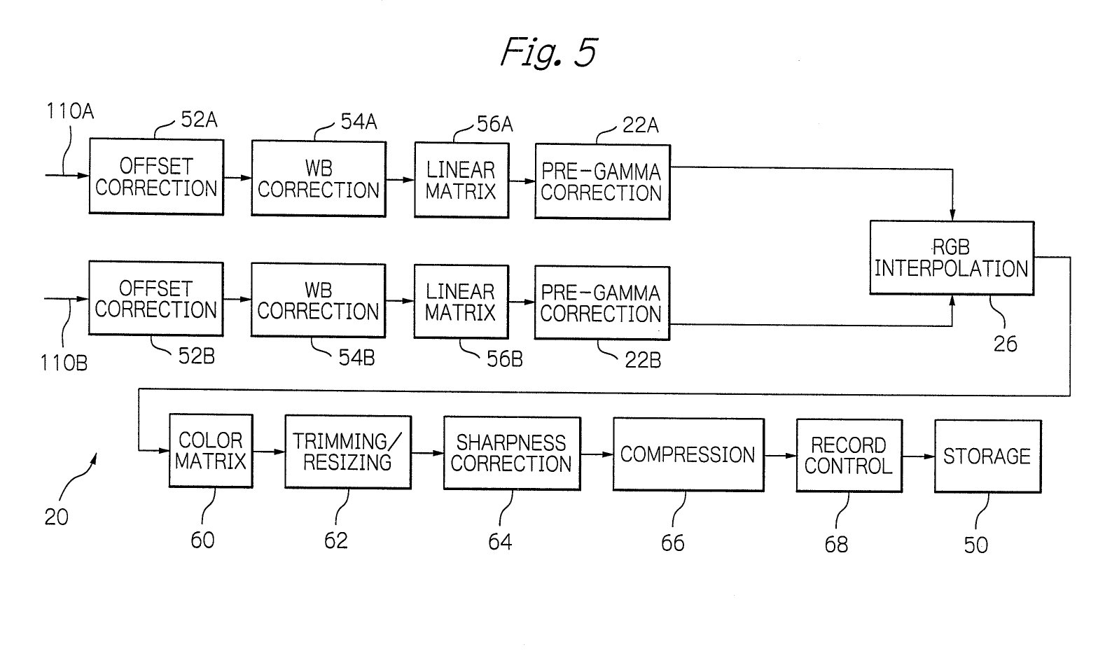

FIG. 5 is a functional schematic block diagram schematically showing a specific configuration of the signal processor 20. It should be noted that various functions shown in FIG. 5 may be executed in any desired sequence instead of a specific sequence to be described hereinafter. The signal processor 20 included in the illustrative embodiment is characterized in that it executes the following unique processing when the user selects a resolution priority mode included in the image quality mode list of FIG. 4.

The unique processing mentioned above is such that a main and an auxiliary pixel signal 110A and 110B are subject to pre-gamma correction at blocks 22A and 22B, respectively, and then subject to RGB interpolation 26. Stated another way, as shown in FIG. 2, the signal processor 20 does not combine the outputs of the main and auxiliary pixels 14 and 16 located at physically different positions from each other to thereby produce a single pixel, but handles each of the main and auxiliary pixels 14 and 16 as a single pixel and uses all signals available with the pixels 14 and 16 in order to guarantee the number of pixels. With this unique processing, it is possible to produce an image having high resolution and broad-band luminance, compared to processing that broadens the dynamic range by, e.g., combining main and auxiliary pixels.

The prerequisite with the processing of FIG. 5 is that the signal available with the auxiliary pixels 14 be only one-fourth of the signal available with the main pixels and must therefore be quadrupled before the RGB interpolation 26.

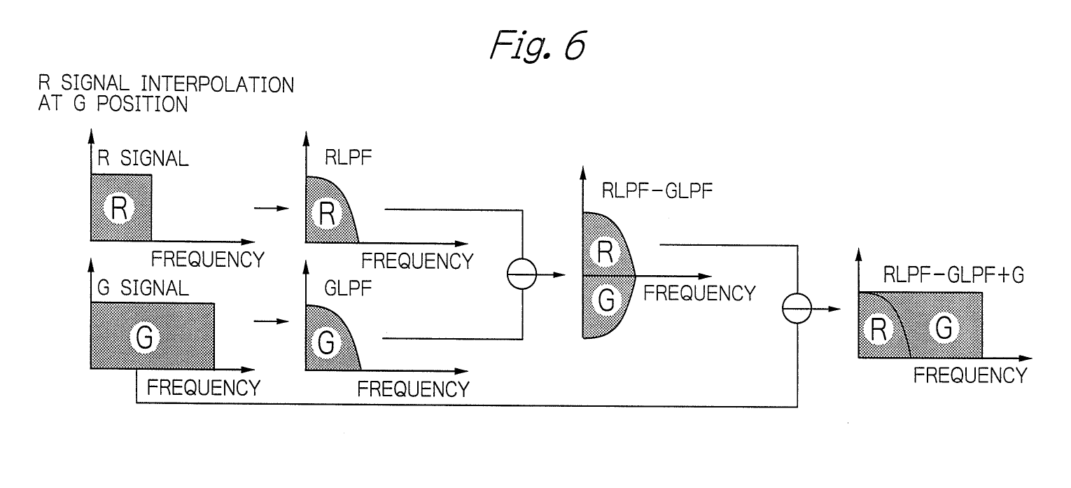

FIG. 6 demonstrates the RGB interpolation 26 specifically. Briefly, the RGB interpolation 26 performs interpolation with a given pixel while giving consideration to colors absent at the pixel, thereby obtaining all of three primary colors R, G and B at each pixel. For example, at the position of a G pixel, the RGB interpolation 26 generates signals of the other colors, i.e., R and B for thereby interpolating the image signal. FIG. 5 demonstrates a specific case wherein, assuming that a high frequency signal is gray, an R signal is interpolated in a G position. As shown, frequency components of an R and a G signal are generated from around a G position and passed through respective low-pass filters (LPFs), and then the resulting value GLPF is subtracted from the other resulting value RLPF to produce a difference, RLPF−GLPF. Subsequently, the difference RLPF−GLPF is added to the original G signal to form a resultant value, RLPF−GLPF+G, whereby low-frequency color signals are interpolated with the high frequency signal being maintained. This is successful to generate a broad-band luminance signal.

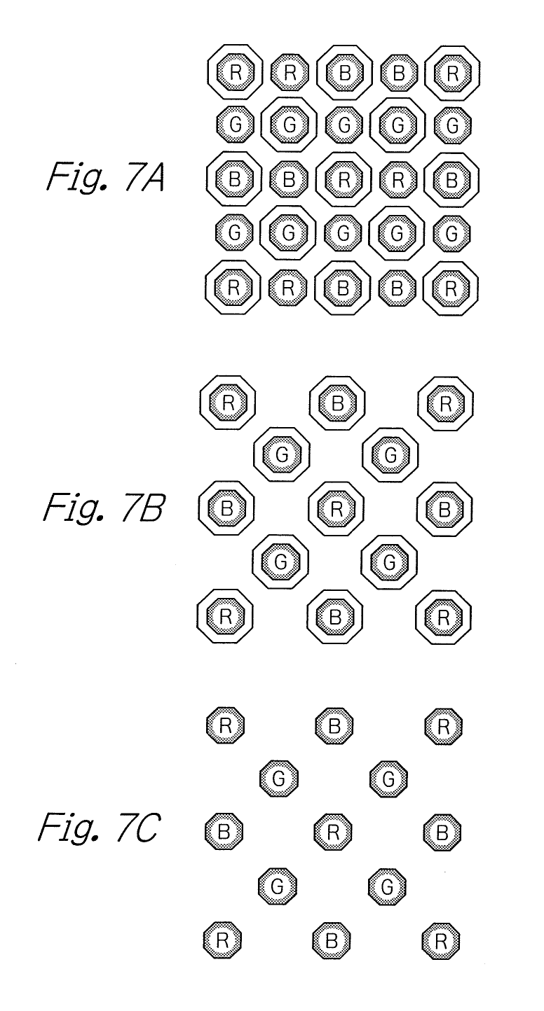

FIGS. 7A, 7B and 7C show a so-called honeycomb pattern which is another specific pattern applicable to the arrangement of pixels of the image sensor 12, FIG. 1. The honeycomb pattern may be implemented by a single color filter shown in FIG. 7A or color filters shown in FIGS. 7B and 7C stacked together. Of course, the honeycomb pattern is replaceable with the Bayer pattern stated previously, if desired. It is to be noted that the Bayer pattern and honeycomb pattern are both applicable to other embodiments to be described later also.

The remaining sections or constituent elements of the digital camera 10 shown in FIG. 1 will be described specifically hereinafter. Optics 32 is configured to focus light input from an imaging field on the image sensor 12, and includes lenses, an aperture, an automatic focus (AF) function and an aperture control mechanism. The image sensor 12 is connected to a driver 34 configured to feed a drive signal for charge transfer to the image sensor 12. The driver 34 is, in turn, connected to a timing signal generator 36 configured to generate timing pulses which are necessary for the driver 34 to generate the drive signal and feed the timing pulses to the driver 34. The timing signal generator 36 is connected to a system controller 38 that controls various sections of the camera 10 including the timing signal generator 36.

A preprocessor 40, also controlled by the system controller 38, includes various circuits for executing preprocessing, i.e., a correlated double sampling (CDS) circuit, a gain-controlled amplifier (GCA), an analog-to-digital converter (ADC) and so forth. The system controller 38 is connected to the control panel 18 and controls the various sections of the circuitry in response to an operation signal input from the control panel 18. Further, the system controller 18 is connected to a strobe 42 configured to illuminate a desired subject with a light source included therein at the time of a shot. An image signal processed by the preprocessor 40 is temporarily written to a buffer memory 44, which is a volatile or non-volatile storage device, and then delivered to the signal processor 20 over a system bus 46. The signal processor 20 executes processing matching with the image equality mode selected by the user on the image signal input from the buffer memory 44.

The system controller 38 and a storage interface (IF) circuit 48 are connected to the system bus 46 together with the buffer memory 44 and signal processor 20. The system controller 38 is capable of controlling all the circuits connected to the system bus 46. A storage 50 is connected to the storage IF circuit 48 and adapted to record the image signal subjected to preselected processing by the signal processor 20.

The processing particular to the circuitry of FIG. 5 will be described in more detail hereinafter. As shown, a main image signal and an auxiliary image signal produced from the main pixel 14 and auxiliary pixel 16, respectively, are subject to identical processing up to the pre-gamma corrections 22A and 22B, respectively.

More specifically, offset corrections 52A and 52B are processing adapted for correcting offset errors included in the main and auxiliary image signals 110A and 110B, respectively. In the following, signals are designated with reference numerals of connections on which they are conveyed. White balance (WB) corrections 54A and 54B are processing adapted for correcting part of an image that should originally be of an achromatic color, i.e., white, gray or black to the chromatic color to thereby control the color balance of the entire image. This is done by controlling the brightness of each of an R, a G and a B level on a tone curve. Linear matrix processings 56A and 56B are adapted for adjusting hue and color saturation characteristic by color matrix processing to thereby enhance color reproducibility to such a degree that tones appearing as natural as to eye are obtained. The pre-gamma corrections 22A and 22B are adapted to execute gamma correction beforehand.

Further, a color matrix processing 60 is adapted to convert an RGB signal output from the RGB interpolation 26 to a luminance signal and color signals Y, R-Y and B-Y by matrix processing. Trimming/resizing processing 62 is adapted to selectively trim an image and/or to enlarge or reduce the image to a preselected size. A sharpness correction 64 is adapted for correcting the sharpness of an image. An image compression 66 is adapted for compressing image data on the basis of, e.g., JPEG (Joint Photographic coding Experts Group) standard. Further, a record control 68 is adapted for converting an image signal to a preselected image file that can be stored in the storage 50.

A second, alternative, embodiment of the image pickup apparatus in accordance with the present invention will be described hereinafter. The configuration of the digital camera in accordance with the second embodiment and the pixel pattern and output characteristic of the image sensor included therein maybe identical with those shown in FIGS. 1, 2 and 3, and detailed description thereof will not be made repetitively in order to avoid redundancy. The second embodiment can therefore generate an image signal having the maximum dynamic range of 400% by smoothly combining a high-output and a low-output signal with each other in accordance with the luminance value. However, not all scenes to be picked up need the dynamic range of 400%, but sensitivity is indispensable when priority is given to the S/N (Signal-to-Noise) ratio.

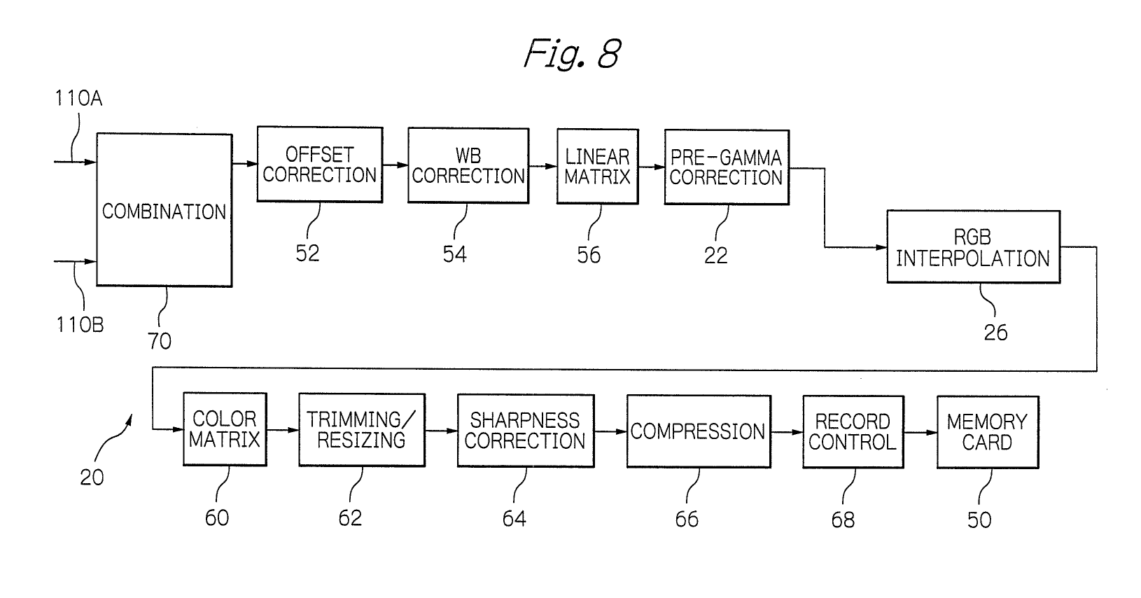

In light of the above, in the second embodiment, there will be described an image processing method to be executed when the user selects a sensitivity priority mode, i.e. , a mode that implements high sensitivity pickup by attaching importance to the S/N ratio. FIG. 8 is a detailed functional flock diagram schematically showing another specific configuration of the signal processor 20, FIG. 1. In the illustrative embodiment, the signal processor 20 is characterized in that when the sensitivity priority mode is selected by the user, the main and auxiliary pixel signals 110A and 110B are first combined by a combination 70 different from the conventional combination adapted for broadening the dynamic range.

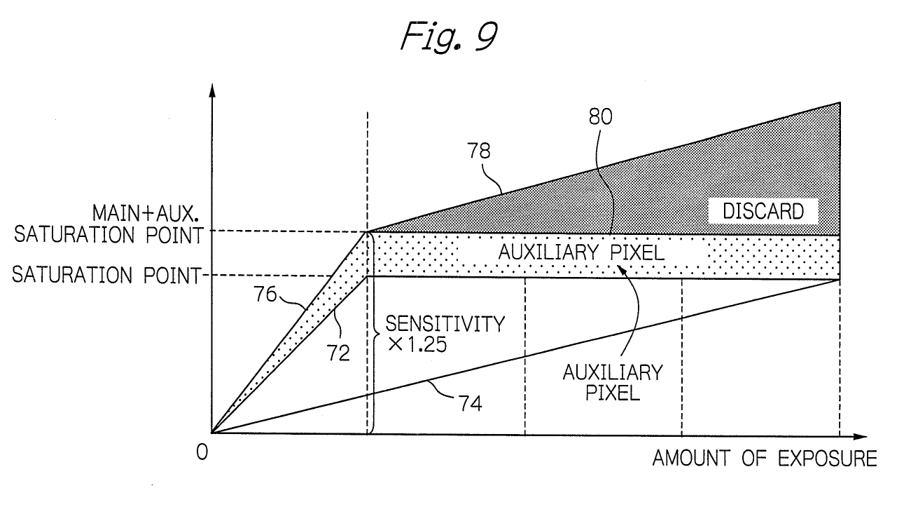

FIG. 9 demonstrates the combination processing assigned to the combination 70, FIG. 8. As shown, in the illustrative embodiment, the combination 70 adds a main pixel output signal 72 and an auxiliary pixel output signal 74 to thereby produce a single output signal 76. When the composite output signal 76 exceeds a saturation point, labeled MAIN+AUX. SATURATION POINT in FIG. 9, representative of the sum of the main and auxiliary pixels, it is expected to turn into a signal 78. However, in the illustrative embodiment, part of the signal 76 exceeding the MAIN+AUX SATURATION POINT is clipped off, so that the signal 76 turns into an output signal 80. Consequently, an output signal for a certain amount of exposure is higher than the output signal 72 derived only from the main pixel and is provided with sensitivity 1.25 times as high as the sensitivity of the main pixel.

The image signal thus output with enhanced sensitivity by the combination 70 shown in FIG. 8 is then subject to the following sequence of processing beginning with offset processing. The sequence following the combination 70 is identical with the sequence shown in FIG. 5 and will not be described specifically in order to avoid redundancy.

A third, another alternative, embodiment of the image pickup apparatus in accordance with the present invention will be described hereinafter. The configuration of the digital camera in accordance with the third embodiment and the pixel pattern and output characteristic of the image sensor included therein are identical with those shown in FIGS. 1, 2 and 3, and detailed description thereof will not be made in order to avoid redundancy. The third embodiment can therefore also generate an image signal having the maximum dynamic range of 400% by smoothly combining a high-output and a low-output signal in accordance with the luminance value.

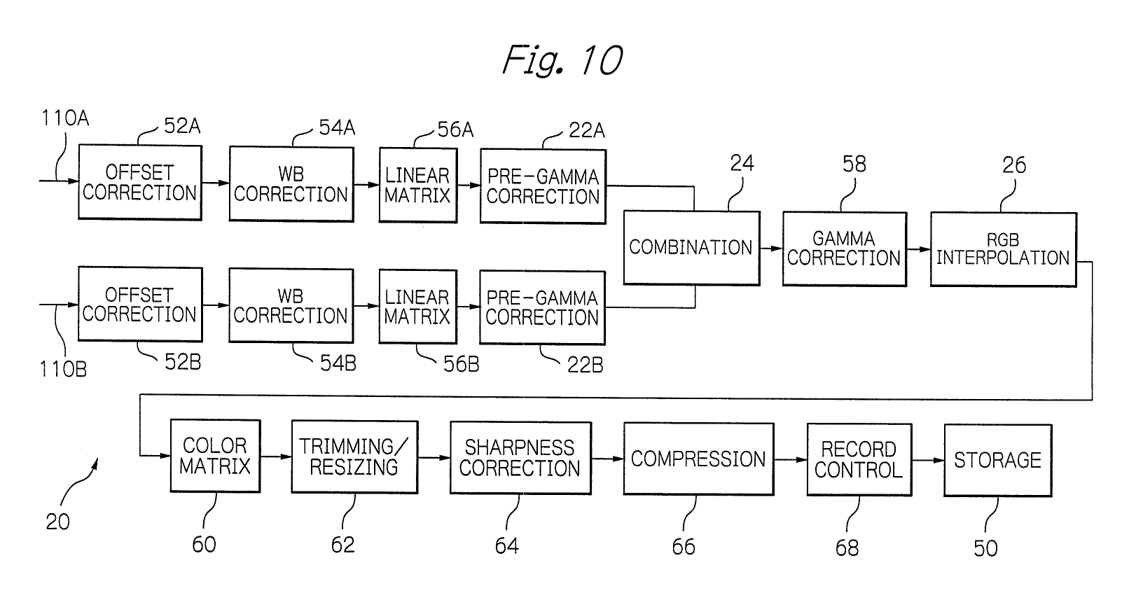

In the third embodiment, an image processing method to be executed when the user selects a dynamic range priority mode while watching the image quality list of FIG. 4 will be described specifically. FIG. 10 is a functional block diagram schematically showing another specific configuration of the signal processing 20, FIG. 1. The signal processing 20 shown in FIG. 10 is characterized in that when the dynamic range priority mode is selected, the main and auxiliary signals, respectively subjected to pre-gamma correction by the pre-gamma corrections 22A and 22B, are combined in accordance a preselected rule by a combination 24, so that an image signal having a broader dynamic range than the first output signal is output. In this manner, the combination 24 is processing to be executed when the user selects the dynamic range priority mode. With the combination 24, it is possible to produce an image having the maximum dynamic range of 400% by combining the main and auxiliary pixel signals.

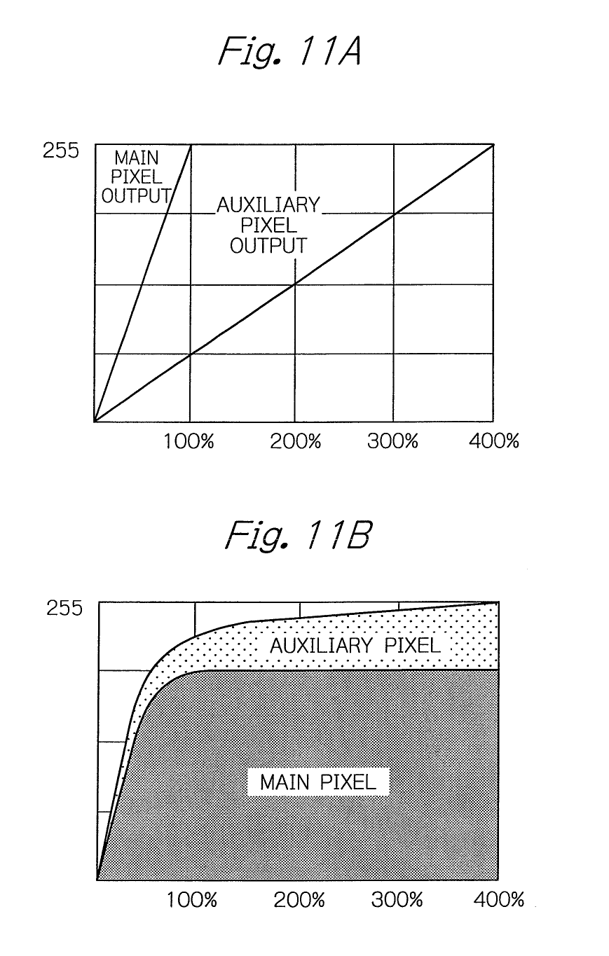

Thus, a main and an auxiliary pixel output signal shown in FIG. 11A are smoothly combined, as shown in FIG. 11B, implementing thereby an image signal having the maximum dynamic range of 400%. More specifically, at the same time as the dynamic range of the main pixel is broadened up to 400%, an image signal having higher sensitivity than the auxiliary pixel output signal and having a smooth distribution for luminance is achieved.

A fourth, still another alternative, embodiment of the image pickup apparatus in accordance with the present invention will be described hereinafter. The configuration of the digital camera in accordance with the fourth embodiment and the pixel pattern and output characteristic of the image sensor included therein are identical with those shown in FIGS. 1 through 3, and detailed description thereof will also not be made in order to avoid redundancy. The fourth embodiment can therefore also generate an image signal having the maximum dynamic range of 400% by smoothly combining a high-output and a low-output signal in accordance with the luminance value. However, not all scenes to be picked up need the dynamic range of 400%, but colors matching the color temperature of a scene are sometimes desired.

In light of the above, in the fourth embodiment, there will be described an image processing method to be executed when the user selects a color reproducibility priority mode. An integrator 40 shown in FIG. 1 has a scene distinguishing function for detecting the color temperature of a scene from the output signal of the preprocessor 40, determining whether or not the color temperature thus detected is deviated to either the high side or the low side, and feeding the result of such a decision to the signal processor 20, FIG. 1.

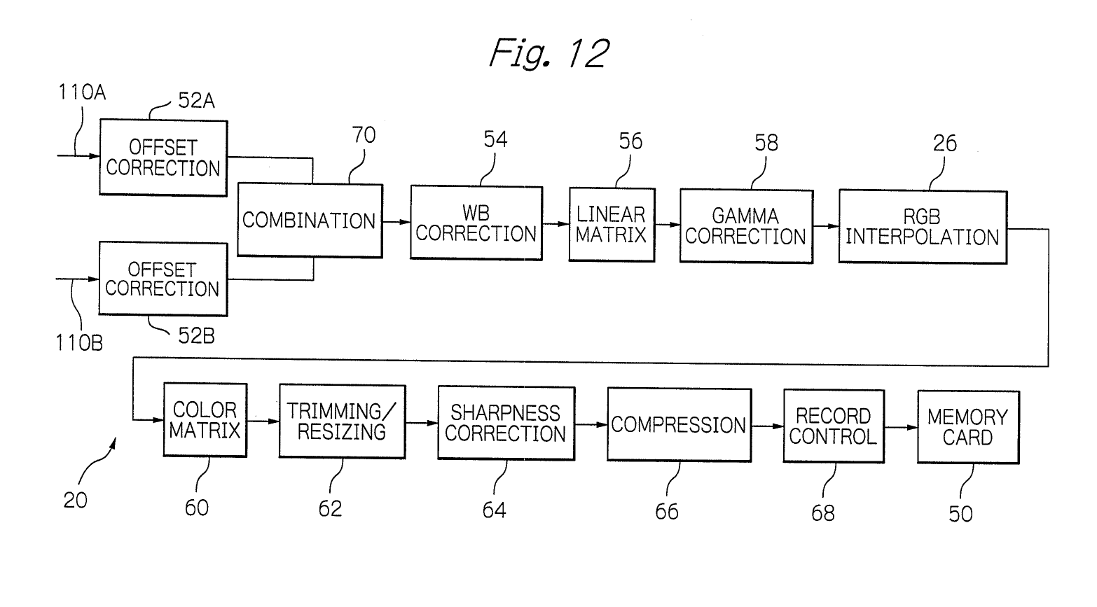

FIG. 12 is a functional block diagram schematically showing another specific configuration of the signal processor 20 particular to the fourth embodiment. As shown, the signal processor 20 is characterized in that when the user selects a color reproducibility priority mode while watching the monitor 30 of FIG. 4, the main and auxiliary pixel signals are subject to the WB correction 54 after being combined by the combination 70 in accordance with the result of the above decision made on the scene. The combination 70 may be executed in exactly the same manner as in the second embodiment.

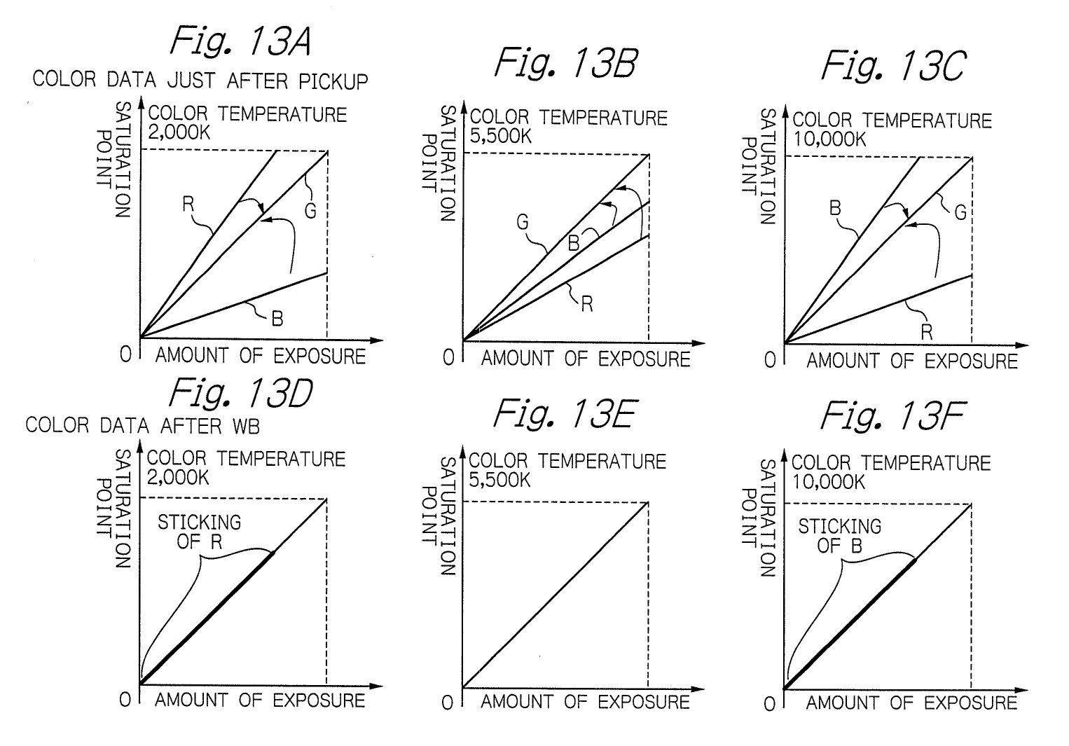

FIGS. 13A through 13F are graphs useful for understanding the problem of the conventional processing that applies WB correction to each of different color data just after pickup without executing the combination stated above. For example, as shown in FIG. 13A, in the case of an image with color temperature of as low as 2,000 K, i.e., a generally reddish image, an R-pixel signal output is the highest while a B-pixel signal output is the lowest, so that a G/R ratio is small. As a result, even if the main R pixel saturates before the main G and main B pixels for a given amount of exposure. When such color signals are subject to WB correction, a WB gain for the R pixel becomes smaller than “1”. Consequently, as shown in FIG. 13D, even if the signal of the main R pixel is matched to the main G pixel by gain correction, the R pixel signal is lost due to saturation except for part thereof labeled “STICKING OF R”, so that reddishness is lost in the highlight portion of the resulting image where luminance is higher than preselected luminance.

Likewise, as shown in FIG. 13, in the case of an image with color temperature of as high as 10,000 K, i.e., a generally bluish image, the main B pixel saturates before the main G pixel and main R pixel, i.e., a G/B ratio is small. Consequently, a WB gain for the B pixel becomes smaller than “1”. As a result, as shown in FIG. 13F, the B pixel signal is lost due to saturation except for part thereof labeled “STICKING OF B”, so that bluishness is lost in the highlight portion of the resulting image where luminance is higher than preselected luminance.

As shown in FIG. 13B, if the color temperature of a scene is about 5,500 K, neither the main B pixel nor the main R pixel saturates before the main G pixel. Therefore, as shown in FIG. 13E, even if WE correction is executed by increasing the gain, neither of the tints is lost. However, when color temperature is extremely high or extremely low, either of the tints is lost in a highlight portion where luminance is higher than preselected luminance.

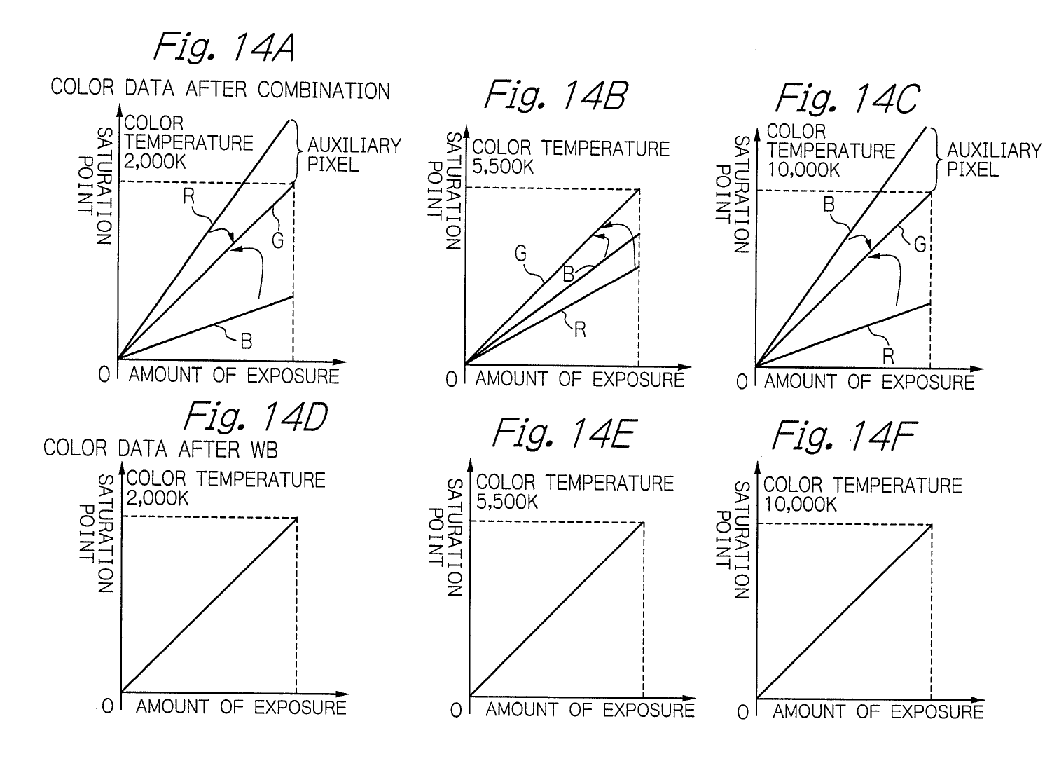

On the other hand, FIGS. 14A through 14F are graphs also useful for understanding output signals achievable with the illustrative embodiment that subjects the main and auxiliary pixel signals to the combination 70 in accordance with the result of the decision made on a scene and then subjects them to the WB correction 54, as described with reference to GI. 13. As seen from FIG. 14A, when the color temperature of the scene is high, as determined by the integrator 90, the signal processor 20 adds the auxiliary pixel to the R-pixel output signal by the combination 70 to thereby raise the saturation point. Consequently, as shown in FIG. 14D, reddishness is not lost even when the WB correction 54 is executed after the combination 70.

Likewise, as shown in FIG. 14C, when the color balance of the scene is low, as determined by the integrator 90, the signal processor 20 raises the saturation point of the B-pixel output signal. As a result, as shown in FIG. 14F, bluishness is not lost despite the WB correction 54. As shown in FIGS. 14B and 14E, when color temperature is not extremely high or extremely low, WB correction can, of course, be executed without any problem.

As stated above, the illustrative embodiment combines the main and auxiliary pixel outputs with each other in accordance with a WB gain value in such a manner as to prevent the colors from saturating and then applies WB correction to the resulting composite output and can therefore execute WB correction over a broader range of color temperatures.

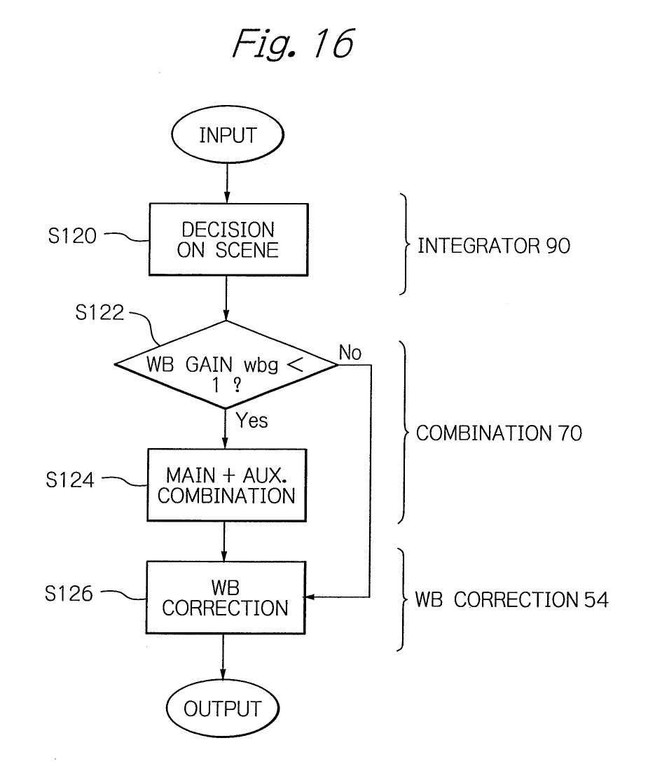

FIG. 16 is a flowchart demonstrating the image processing unique to the illustrative embodiment and executed by the combination 70 of FIG. 12, included in the integrator 90 and signal processor 20, FIG. 1, and WB correction 54. As shown, the integrator 90 makes a decision on the scene (step S120), as stated previously, and delivers the result of the decision to the signal processor 20. In response, the processor 20 executes the offset corrections 52A and 52B with the main and auxiliary pixel signals 110A and 110B input thereto and then determines, based on the result of the above decision, whether or not the WB gain of either one of the R and B pixels is smaller than “1” (step S122). If the answer of the step S122 is negative (No), meaning that the WB gains of the R and B pixels both are greater than “1”, the signal processor 20 executes the WB correction 54 (step S126). Stated another way, the main and auxiliary pixel signals are simply passed through the combination 70 without being subject to any processing.

If the answer of the step S122 is positive (Yes), meaning that the WB gain for the R or the B pixel is smaller than “1”, then the signal processor 20 executes the main and auxiliary pixel combination described with reference to FIG. 14 (step S124). This is followed by the WB correction 54 (step S126).

It is to be noted that linear matrix processing and consecutive processing that follow the WB correction 54 in FIG. 12 are identical with the sequence of processing shown in FIG. 5 and will not be described specifically in order to avoid redundancy.

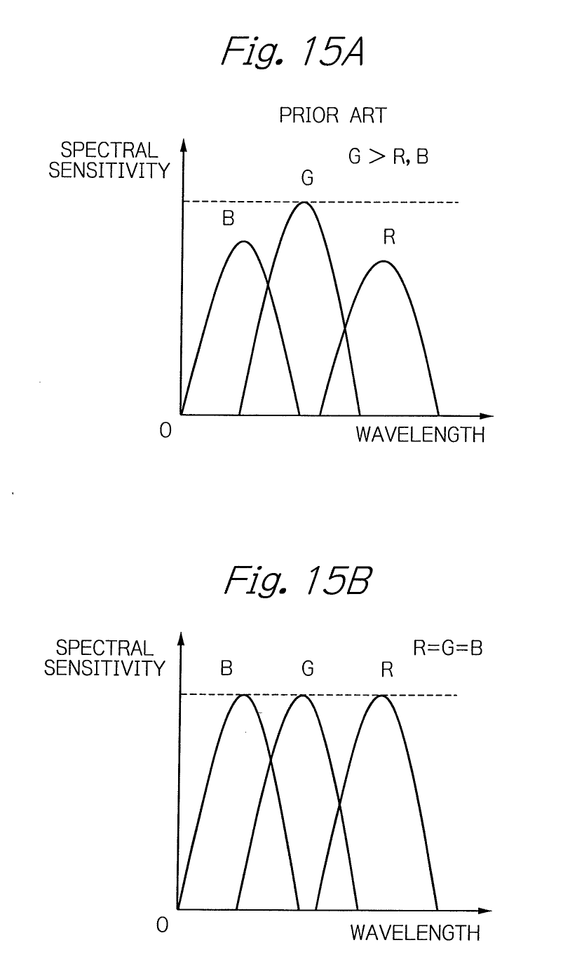

FIGS. 15A through 15F are graphs useful for understanding the comparison of the conventional spectral sensitivity ratios and spectral sensitivity ratios particular to the illustrative embodiment. As shown in FIG. 15A, it has been customary to establish RGB spectral sensitivity ratios of G>R and G>B in consideration of color temperature following capability. By contrast, as shown in FIG. 15B, the illustrative embodiment is capable of establishing a spectral sensitivity ratio of 1:1:1 to thereby improve the S/N ratios of the R and B pixel output signals. The ratio of 1:1:1 may be established as to spectral sensitivity itself or the position of fine weather which is frequently picked up, as desired.

A fifth, further alternative, embodiment of the image pickup apparatus in accordance with the present invention will be described hereinafter. The fifth embodiment is characterized in that it allows the user to freely select any one of the plurality of image quality modes shown in FIG. 4, i.e., any one of the image processing methods particular to the first to fourth embodiments. The fifth embodiment is also practicable with the configuration of the digital camera, pixel arrangement of the image pickup section and output characteristic described with reference to FIGS. 1 through 3. Also, the signal processor shown in FIG. 1 should only be configured to execute image processing in the sequence shown in FIG. 8, 10 or 12.

More specifically, the illustrative embodiment allows the user of the digital camera to operate the control panel 18, FIG. 4, for selecting any one of the resolution priority mode corresponding to the first embodiment, sensitivity priority mode corresponding to the second embodiment, dynamic range priority mode corresponding to the third embodiment and color reproducibility priority mode corresponding to the fourth embodiment, while watching the monitor 30, FIG. 4. In response, an operation signal indicative of the image quality mode thus selected is fed from the control panel 18 to the system controller 38, so that the system controller 38 causes the signal processor 20 to switch the image processing method accordingly.

A sixth, still further alternative, embodiment of the image pickup apparatus in accordance with the present invention will be described hereinafter. Briefly, the sixth embodiment is characterized in that it automatically analyzes the pickup environment and selects one of the image quality modes of FIG. 4 matching with the pickup environment. The sixth embodiment is identical in configuration with the fifth embodiment.

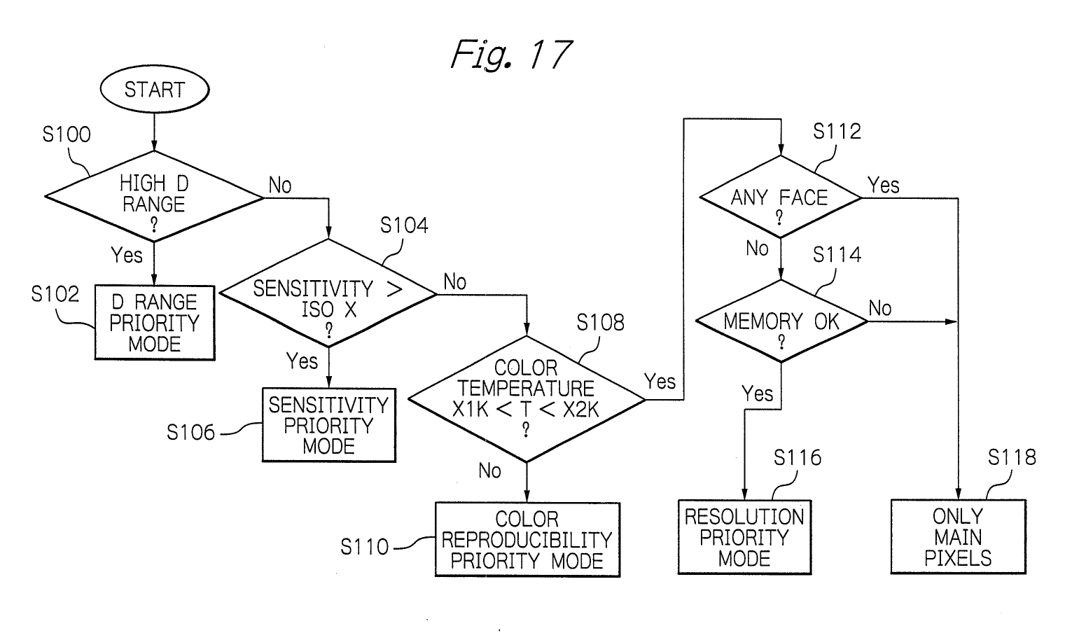

FIG. 17 is a flowchart demonstrating automatic pickup environment analysis to be executed by the system controller 38, FIG. 1, in accordance with the sixth embodiment. As shown, the system controller 38 determines whether or not the dynamic range must be broadened for guaranteeing higher gradation (step S100). This decision can be made by an automatic tone control (ATC) scheme or an automatic tone mapping (ATM) scheme. If the answer of the step S100 is Yes, then the system controller 38 selects the dynamic range priority mode, i.e., executes the image processing particular to the third embodiment (step S102).

IF the answer of the step S100 is No, meaning that the dynamic range does not have to be broadened, then the system controller 38 determines whether or not sensitivity must be increased on the basis of the brightness or luminance level of the scene (step S104). If the answer of the step S104 is Y, the system controller 38 selects the sensitivity priority mode, i.e., the image processing particular to the second embodiment (step S106). While in the illustrative embodiment the system controller 38 makes a decision on the dynamic range mode first, it may alternatively make a decision on the sensitivity priority mode first, if desired.

If the answer of the step S104 is No, meaning that sensitivity does not have to be increased, then the system controller 38 determines whether the color temperature of the scene lies in a preselected range or whether it is extremely high or extremely low (step S108). If the answer of the step S108 is Yes, the system controller 38 selects the color reproducibility priority mode, i.e., the image processing particular to the fourth embodiment (step S110).

If the answer of the step S108 is Yes, then the system controller 38 determines whether the subject to be picked up is a landscape or similar inanimate matter or whether it is an animate matter including a human face or an animal face. For such recognition of an image, there may be used any one of conventional technologies. If the answer of the step S112 is No, meaning that the subject does not include a human face or an animal face, the system controller 38 checks the capacity of the storage 50 (step S114) and selects, if the capacity has a margin, the resolution priority mode, i.e., the image processing particular to the first embodiment (step S116).

If the answer of the step S112 is Yes or if the answer of the step S114 is No, then the system controller 38 forms an image signal by using only the output signal derived from the main pixels 14 (step S118).

In summary, it will be seen that the present invention provides an image pickup apparatus capable of selectively using one of a plurality of image processing methods in accordance with the user's choice or the pickup environment for thereby producing a desired image signal.

The entire disclosure of Japanese patent application No. 2006-084215 filed on Mar. 24, 2006, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. An image pickup apparatus comprising:
a solid-state image pickup device in which pixels, each of which is constituted by a first photosensitive portion and a second photosensitive portion lower in sensitivity than said first photosensitive portion, are bidimensionally arranged to form a single frame, said solid-state image pickup device being capable of producing, by combining a first output signal and a second output signal produced from said first photosensitive portions and said second photosensitive portions, respectively, according to a predetermined rule, an image signal having a broader dynamic range than the first output signal; and
a signal processor selectively operative in a first mode giving priority to resolution or a second mode giving priority to sensitivity,
said signal processor generating in the first mode, when selected, an image signal in which the first output signal and the second output signal of each pixel are used independently of each other without being combined over the single frame,
said signal processor generating in the second mode, when selected, an image signal by adding the first output signal and the second output signal to each other over the single frame.

2. The apparatus in accordance with claim 1, wherein said first photosensitive portions and said second photosensitive portions are arranged in either one of a honeycomb pattern and a Bayer pattern in a single layer or a plurality of layers.

3. The apparatus in accordance with claim 1, wherein said apparatus comprises a digital camera.

4. The apparatus in accordance with claim 1, wherein said apparatus comprises a cellular phone.

5. The apparatus in accordance with claim 1, further comprising a manual controller operative in response to a manipulation of a user for selecting the first mode or the second mode.

6. The apparatus in accordance with claim 1, further comprising a system controller for analyzing an image pickup environment to select the first mode or the second mode.

7. The apparatus in accordance with claim 6, further comprising a storage for storing therein the image signal,
said system controller checking a storage capacity of said storage, and selecting the first mode when the capacity has a margin.

8. The apparatus in accordance with claim 6, wherein said system controller makes a decision on the second mode first.

9. The apparatus in accordance with claim 6, wherein said system controller makes a decision on the first mode first.
